(19) United States
(12) Patent Application Publication
(10) Pub. No.: US 2006/0119666 A1
(43) Pub. Date: Jun. 8, 2006

(54) Thermal head and manufacturing method thereof

(75) Inventors: Sinya Yokoyama, Niigata-ken (JP); Satoru Sasaki, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/287,800

(22) Filed: Nov. 28, 2005

(30) Foreign Application Priority Data
Dec. 3, 2004 (JP) 2004-350768

(51) Int. Cl. B41J 2/05

(52) U.S. Cl. 347/59

(57) ABSTRACT

A thermal head includes printing dots disposed with a predetermined pitch; common electrode groups applying a common electrical potential to all of the printing dots; individual electrode groups individually connected to each of the printing dots, the common electrode groups and the individual electrode groups being arranged at predetermined intervals in each divided electrode group; driving ICs that are provided in each divided electrode groups, and selectively supply currents to the printing dots through each of the individual electrodes to selectively supply a current to each of the individual electrodes included in each of the electrode groups; and dummy resistor patterns formed at predetermined intervals in the regions between the adjacent electrode groups so as not to be connected to both the printing dots and the driving ICs.

### BACKGROUND OF THE INVENTION

1. Field of the Invention

The present invention relates to a thermal head that is mounted on, for example, a thermal transfer printer, and the manufacturing method thereof.

2. Description of the Related Art

A thermal head includes a heat accumulating layer which is provided on a substrate having excellent heat radiating property and is made of high heat insulating material such as glass, a plurality of heating resistors that generates heat by supplying currents thereto, individual electrode groups electrically connected to the heating resistors, respectively, common electrode groups applying a common electrical potential to all of the printing dots. The thermal head performs a print by pressing the heating resistors from which heat is generated by the common electrodes and the individual electrodes to the matter to be printed, which is wound on an ink-ribbon and a platen-roller. The common electrodes and the individual electrodes are connected to both ends of the heating resistors in the longitudinal direction thereof, respectively, and are linearly arranged in the longitudinal direction of the heating resistors. However, in order to reduce the size of the substrate and arrange the heating resistors on the edge of the substrate, a return-type thermal head in which the common electrodes are returned has also been proposed. In the return-type thermal head, for example, one printing dot is composed of two heating resistors of which one pair of ends are connected to each other by a conductor. Each of the individual electrodes is connected to the other end of one heating resistor, and each of the common electrodes is connected to the other end of the other heating resistor.

The thermal head can be manufactured, for example, through the following processes.

First, a resistor film is formed on the overall substrate having the heat accumulating layer, and an insulating barrier layer for specifying a length of each of the heating resistors to be formed is formed on the resistor film. The region of the resistor film, which is covered with the insulating barrier layer, will become a plurality of heating resistors thereafter. When the insulating barrier layer is formed, a resist film is formed on the overall insulating barrier layer and resistor film, and then resist patterns are formed by exposure and development. A positive-type resist film is generally used, and exposed portions of the resist film are dissolved by developing solution. Subsequently, the resistor film exposed from the resist patterns is removed by, for example, etching, and then the resist patterns are removed. After the removal of the resist patterns, a conductor film is formed over all of the exposed heat accumulating layer, the resistor film, and the insulating barrier layer. Subsequently, parts of the conductor film are removed to form a conductor for electrically connecting the adjacent heating resistors to each other, common electrode groups connected to the plurality of heating resistors, and individual electrode groups individually connected to each of the heating resistors. A pair of heating resistors connected to each other by the conductor composes one printing dot, and the common electrode and the individual electrode are connected to the printing dot in the same direction to each other. Each of electrode pads, which connect a plurality of driving ICs for controlling the supply of current to a plurality of heating resistors by a bonding method, is provided on a part (opposite end to a connecting side, which is connected to the heating resistors) of each of the individual electrodes. The common electrode groups and the individual electrode groups are arranged at predetermined intervals in each of a plurality of electrode groups, and the driving ICs are provided to the divided electrode groups, respectively, to selectively supply a current to each of the individual electrodes included in each of the electrode groups.

The above-mentioned thermal head and the manufacturing thereof have been disclosed in JP-A-8 127144 and JP-A-2000-15859.

In the thermal head in the related art, the resistor film remains over all of the dummy regions, which do not have the common electrodes, the individual electrodes, and the electrode pads, between the adjacent electrode groups. For this reason, at the time of developing the resist, wettability difference of the developing solution occurs in the vicinity of the boundaries between the actual regions in which the resist patterns are formed with a predetermined pitch, and the dummy regions in which the resist film remains all over. Therefore, there is a possibility that the resist patterns formed in the vicinity of the dummy regions are disordered. If the shape and size of the heating resistors are deviated due to the disorder of the resist patterns, the heating value of the heating resistors is varied and thus unevenness of the printing density occurs. Therefore, printing quality deteriorates.

### SUMMARY OF THE INVENTION

The invention has been made to solve the above-mentioned problems, and it is an object of one aspect of the invention to provide a thermal head capable of controlling printing density by specifying shapes of the resistor patterns with high accuracy.

Furthermore, it is an object of another aspect of the invention to provide a thermal head capable of specifying resistor patterns with high accuracy, as long as wettability of the developing solution is uniform at the time when resist patterns are formed by exposure and development to form heating resistors (resistor patterns) That is, a thermal head according to the invention includes printing dots disposed with a predetermined pitch; common electrode groups applying a common electrical potential to all of the printing dots; individual electrode groups individually connected to each of the printing dots, the common electrode groups and the individual electrode groups being arranged at predetermined intervals in each divided electrode group; driving ICs that are provided in each divided electrode group, and selectively supply currents to the printing dots through each of the individual electrodes, so as to selectively supply a current to each of the individual electrodes included in each of the electrode groups; and dummy resistor patterns formed in each of regions between the adjacent electrode groups with a predetermined interval so as not to be connected to both the printing dots and the driving ICs.

In the above-mentioned structure, it is preferable that the dummy resistor patterns be formed with the same pitches as the minimum pitch of the common electrodes and the individual electrodes, which are included in each of the electrode groups. For example, when the common electrodes and the individual electrodes are alternately disposed in the electrode groups, the pitches of the common electrodes and the individual electrodes are to be the minimum pitch.

In the above-mentioned structure, it is preferable that the dummy resistor patterns be arranged parallel to the common electrodes and the individual electrodes which are included in each of the electrode groups, and that the dummy resistor patterns be symmetric with respect to the middle position between the adjacent electrode groups.

In the above-mentioned structure, it is preferable that the common electrodes and the individual electrodes be formed on resistor patterns, which compose the printing dots and generate heat by supplying a current thereto, and the resistor patterns and the dummy resistor patterns be formed with a resistor film made of the same material.

In the above-mentioned structure, it is preferable that each of the printing dots include two heating resistors of which one pair of ends are connected to each other by a conductor, each of the individual electrodes be connected to the other end of one heating resistor, and each of the common electrodes be connected to the other end of the other heating resistor.

Furthermore, according to the invention, in a method of manufacturing a thermal head, which includes: printing dots disposed with a predetermined pitch; common electrode groups applying a common electrical potential to all of the printing dots; individual electrode groups individually connected to each of the printing dots, the common electrode groups and the individual electrode groups being arranged at predetermined intervals in each divided electrode groups; driving ICs that are provided in each electrode group, respectively; and dummy resistor patterns formed at predetermined intervals in the regions between the adjacent electrode groups so as not to be connected to both the printing dots and the driving ICs, resistor patterns constituting the printing dots and the dummy resistor patterns are formed by a photo-lithography method at the same time.

In the above-mentioned method, it is preferable that the common electrode groups and the individual electrode groups be laminated on the resistor patterns.

### BRIEF DESCRIPTION OF THE DRAWINGS

FIG. 1 is a schematic view showing an entire structure of a thermal head according to the invention;

FIG. 2 is a pattern plan view showing the structure of the thermal head (except for a protective layer);

FIG. 3 is a pattern cross-sectional view showing a structure of an individual electrode of the thermal head (except of a protective layer);

FIG. 4 is a plan view showing resistor patterns and dummy resistor patterns;

FIG. 5 is a plan view showing one process of the manufacturing processes of the thermal head; and

FIG. 6 is a cross-sectional view showing one process of the manufacturing processes of the thermal head.

### DESCRIPTION OF THE PREFERRED EMBODIMENTS

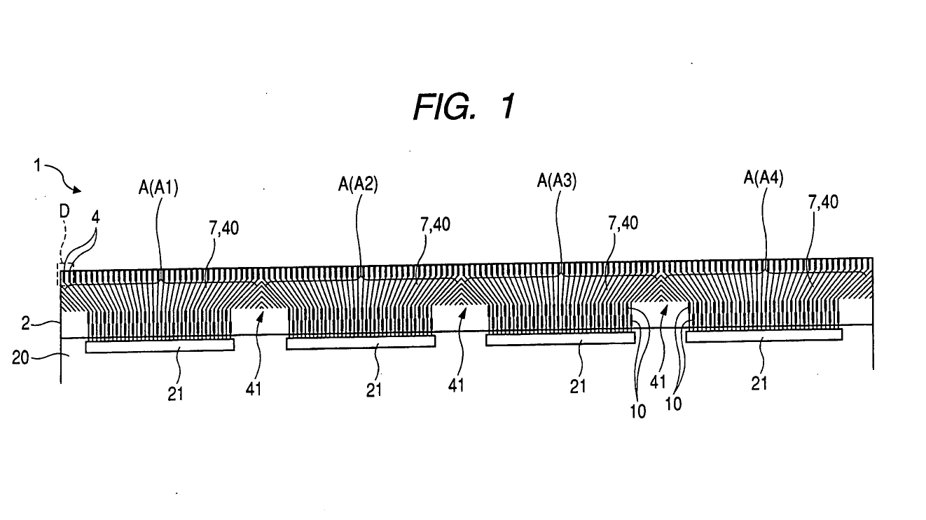

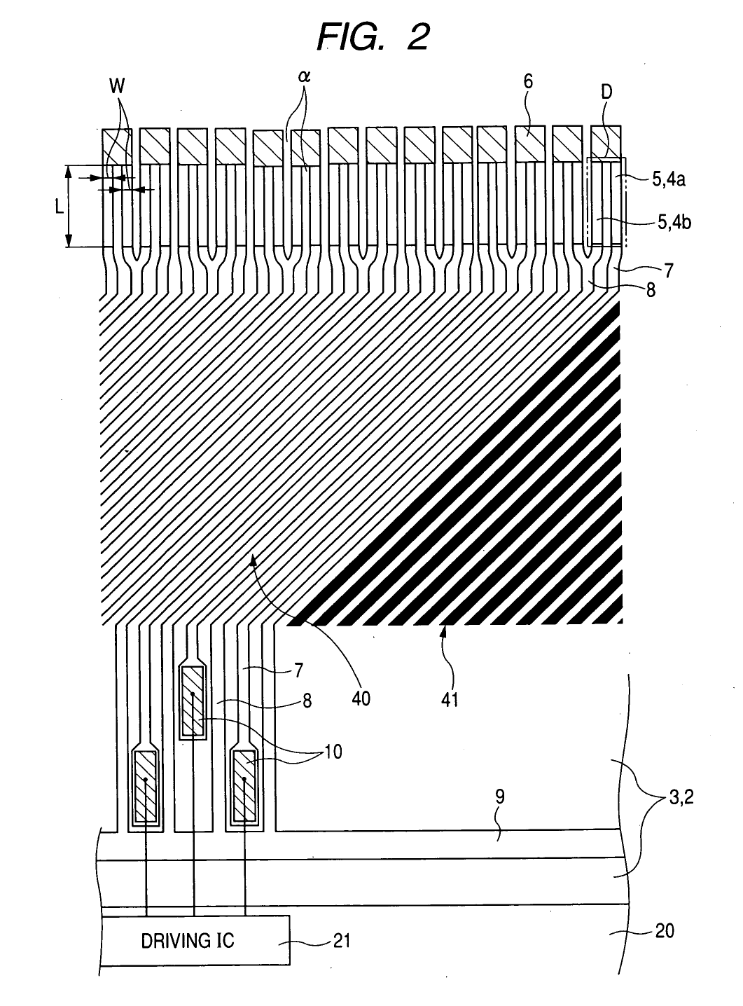

FIG. 1 is a schematic view showing an entire structure of a thermal head according to the invention, FIGS. 2 and 3 are a pattern plan view and a pattern cross-sectional view showing the structure of the thermal head (except for a protective layer).

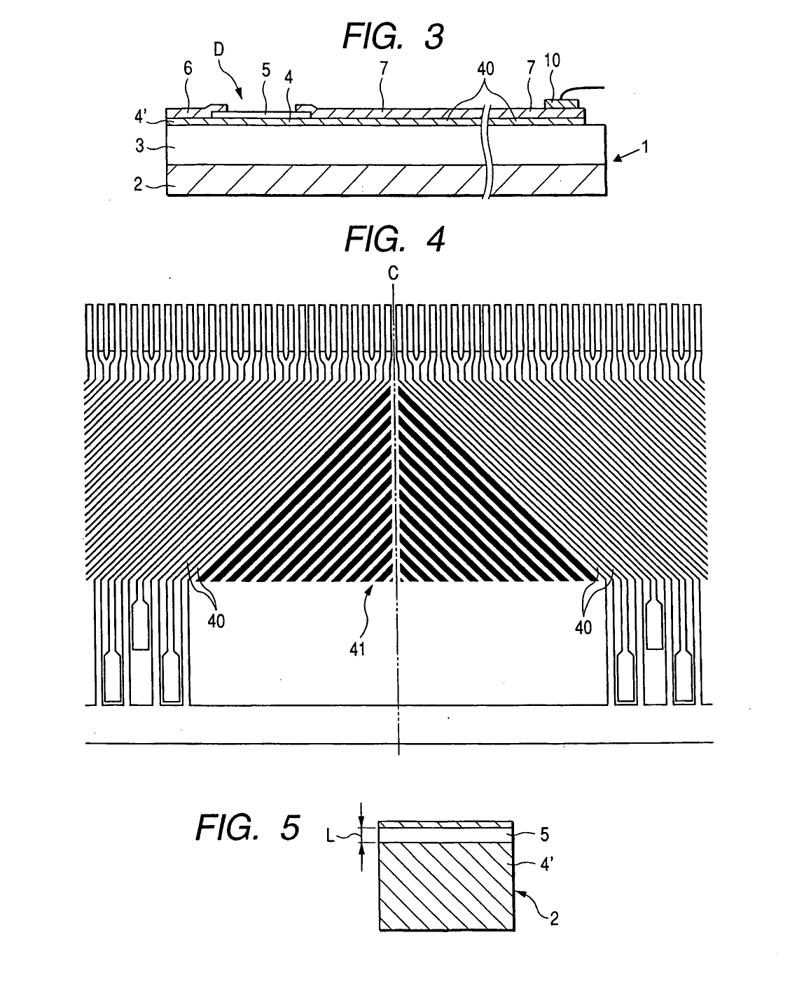

A thermal head 1 includes a heat accumulating layer 3 on a substrate 2 having excellent heat radiating property, and a plurality of heating resistors 4 that are arranged at predetermined intervals on the heat accumulating layer 3 in one line in the horizontal direction in FIGS. 1 and 2. The substrate 2 is made of Si or ceramic material, metal material, or the like, and the heat accumulating layer 3 is made of heat insulating material such as glass. Each of the heating resistors 4 is a part of the resistor patterns 40, which are made of cermet material such as Ta₂N or Ta—SiO₂ and are partially formed on the heat accumulating layer 3, and the surface thereof is covered with an insulating barrier layer 5. The resistor patterns 40 exist in an area in which conductors (contact conductors 6, individual electrodes 7, common electrodes 8, and a common line 9) are formed outside an area formed by the heating resistors 4 (see FIG. 4), and function as a coherent layer for improving coherence between the conductors and the heat accumulating layer 3. The insulating barrier layer 5 is made of insulating material, such as SiO2, SiON, SiAlON, or the like, and specifies the planar dimensions (length L, width W) of the heating resistors 4. Each of the gap areas α through which the heat accumulating layer 3 is exposed is formed between the adjacent heating resistors 4. In the present embodiment, one printing dot D is composed of a pair of adjacent heating resistors 4 (4a, 4b), and a number of printing dots D are arranged in the direction orthogonal to the current direction of the heating resistors 4 (horizontal direction in FIG. 1).

As shown in FIG. 2, in each of a pair of heating resistors 4a and 4b, one pair of ends thereof in the longitudinal direction and the gap therebetween are covered with a rectangular contact conductor 6. In this case, the other end of one heating resistor 4a is connected to an individual electrode 7, and the other of the other heating resistor 4b is connected to a common electrode 8. The individual electrode 7 and the common electrode 8 are connected to the printing dots D in the same direction so as to be alternately arranged in the dot array direction. Each of the gap areas α is formed between the individual electrodes 7 and the common electrodes 8.

Each of the common electrodes 8 is provided for every two printing dots D that are adjacent to each other, and is substantially formed in a Y shape that has a U-shaped part connected to two adjacent heating resistors 4b and a linear part extending from the U-shaped part in the direction parallel to the longitudinal direction of the heating resistors 4b. Each of the ends of the common electrodes 8, which are provided on the opposite side to the heating resistors 4b, is connected to a common line 9. The common line 9 extends in the dot array direction, and is connected to the plurality of common electrodes 8. Furthermore, power is fed to both ends of the common line 9 in the longitudinal direction of the common line 9 (horizontal direction in FIG. 1). Electric power from an external power source, which is provided separately from the substrate 2, is supplied to all of the printing dots D through the common line 9 and the common electrodes 8. In the contact conductors 6, the individual electrodes 7, and the common electrodes 8 according to the present embodiment, each of the ends thereof, which are provided on the side of the heating resistors 4, is formed on the insulating barrier layer 5 by an overlay method. In addition, the common electrodes 8 and the common line 9 are not shown in FIG. 1.

Each of the individual electrodes 7 is provided to each of the printing dots D, respectively. Further, each of the electrode pads 10, which connects each of the driving ICs (integrated circuits) 21 to the individual electrodes 7 by a wire bonding method, is disposed in the direction parallel to the array direction of the printing dots D at the end of each of the individual electrodes 7, which is provided on the opposite side of the heating resistors 4a. In this case, the electrode pads 10 are alternately disposed in a staggered arrangement with narrower pitches than the pitches between the printing dots D. The individual electrodes 7 and the common electrodes 8 are arranged so that electrode groups A (A1 to A4) are spaced from one another.

Each of the driving ICs 21 is a switching element for switching between the electrification and non-electrification of the plurality of heating resistors 4. Each of the driving ICs 21 is provided on the driving unit 20 separate from the substrate 2 to correspond to each of the electrode groups A1 to A4, and selectively supplies a current to each of the individual electrodes 7 included in each of the electrode groups A1 to A4. A pitch between the driving ICs 21 corresponds to a pitch of the electrode pads 10. In addition, FIG. 1 is a schematic view showing the structure of the thermal head 1, wires for connecting the actual electrode pads with the actual driving ICs are arranged at very small intervals of about 50 μn.

The contact conductors 6, the individual electrodes 7, the common electrodes 8, and the common line 9 are made of, for example, Al, Cr, Ti, Ni, W, or the like, and formed on the resistor patterns 40. Although not shown in the drawings, a protective layer with abrasion resistance is formed on the insulating barrier layer 5, contact conductors 6, the individual electrodes 7, the common electrodes 8, and the common line 9 to protect themselves from the contact with the plated-roller.

In the thermal head 1 having the above-mentioned structure, the pitches between the driving ICs 21 are narrower than the pitches between the printing dots D that are composed of a pair of heating resistors 4a and 4b in the dot array direction. Therefore, there are regions between the adjacent electrode groups A (resistor patterns 40 formed below the individual electrodes 7 and the common electrodes 8 included in each of the electrode groups A). Dummy resistor patterns 41 are formed in each of the regions between the adjacent electrode groups A, and are positioned between the heating resistors and the electrode pads in the direction orthogonal to the dot array direction so as not to be connected to both the printing dots D and the electrode pads 10. In FIGS. 2 to 4, the dummy resistor patterns 41 are shown by painting.

FIG. 4 is a plan view showing the resistor patterns 40 and the dummy resistor patterns 41. The dummy resistor patterns 41 are formed simultaneously with the resistor patterns 40 by patterning a resistor film, which is formed over all of the heat accumulating layer 3, by a photo-lithography method. Accordingly, the dummy resistor patterns 41 causes the pattern accuracy of the resistor patterns 40 to be improved. Specifically, the dummy resistor patterns 41 are arranged parallel to the resistor patterns 40 with the same pitches as that of the resistor patterns 40 to be symmetric with respect to the middle position between the adjacent electrode groups A. Hereinafter, regions in which the resistor patterns 40 are formed are referred to as “actual regions (=electrode groups A)”, and regions in which the dummy resistor patterns 41 are formed are referred to as “dummy regions”.

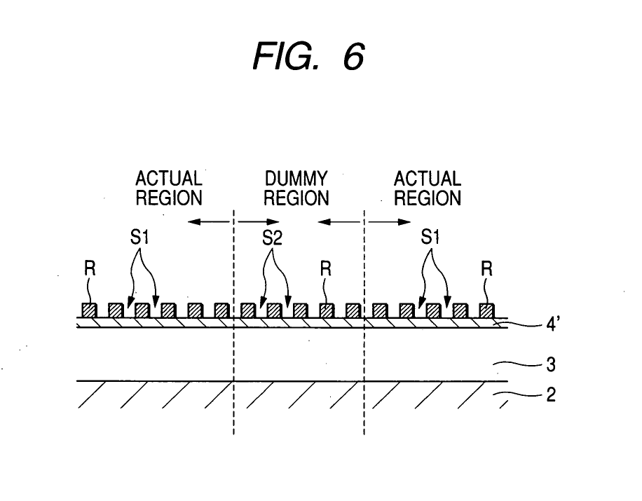

Next, a manufacturing method of the thermal head 1 according to the invention, more particularly, a manufacturing process of the dummy resistor patterns 41 will be described with reference to FIGS. 5 and 6.

First, as shown in FIG. 5, a resistor film 4′ made of cermet material such as Ta₂N or Ta—SiO₂ is formed over all of the substrate 2 having the heat accumulating layer 3, and the insulating barrier layer 5 for specifying a length L of each of the heating resistors to be formed is formed on the resistor film 4′. The region of the resistor film 4′, which is covered with the insulating barrier layer 5, will become a plurality of the heating resistors 4 afterward.

Next, as shown in FIG. 6, a resist film is formed on the overall surface of the resistor film 4′ including the insulating barrier layer 5, and then resist patterns R are formed by exposure and development. A positive-type resist film is generally used, and exposed portions of the resist film are dissolved by developing solution. On the resist patterns R, actual region forming slit groups S1, which correspond to the gap areas α between the individual electrodes 7 and the common electrodes 8, are formed between adjacent heating resistors, and the dummy region forming slit groups S2, which are parallel to the slit of ends of the actual region forming slit groups S1 at a uniform pitch, are formed between the adjacent actual region forming slit groups S1. A width W of each of the heating resistors to be formed is specified by the actual region forming slit groups S1. Since the slits are uniformly formed over all of the resist film by providing the actual region forming slit groups S1 and the dummy region forming slit groups S2, wettability of the developing solution dissolving the resist film is also uniform throughout the overall resist film. Therefore, it is possible to obtain the satisfactory resist patterns R, without having dimensional variation.

Subsequently, the resistor film exposed from the resist patterns R is removed by, for example, etching, and then the resist patterns R are removed. Accordingly, as shown in FIG. 4, the resistor patterns 40 remain on the actual regions, and the dummy resistor patterns 41 remain on the dummy regions between the actual regions. As described above, since unevenness of size does not occur on the resist patterns R that serve as a mask at the time of etching, it is possible to form the resistor patterns 40 with high accuracy. A plurality of heating resistors 4 of which planar dimensions (length L, width W) are specified is obtained through the above-mentioned processes.

When the resistor patterns 40 are formed, a conductor film is formed on the overall exposed heat accumulating layer 3, insulating barrier layer 5, resistor patterns 40, and dummy resistor patterns 41. After that, parts of the conductor film are removed by etching so that the only conductor film positioned on the resistor patterns 40 remains. In this manner, it is possible to obtain the contact conductors 6 electrically connecting the adjacent heating resistors 4, the individual electrodes 7 individually connected to each of the heating resistors 4, the common electrodes 8 connected to the plurality of heating resistors 4, and the common line 9 connected to the common electrodes 8.

Subsequently, each of the electrode pads 10 is provided on the opposite end to a connecting side, which is connected to the heating resistors 4, of each of the individual electrodes 7, the protective layer with abrasion resistance is formed on the surface (the exposed heat accumulating layer 3, insulating barrier layer 5, contact conductors 6, individual electrodes 7, common electrodes 8, and common line 9) of the substrate other than the electrode pads 10. Further, the electrode pads 10 exposed from the protective layer with abrasion resistance, and the driving ICs 21 corresponding to the electrode pads 10 are connected to each other by a wire bonding method, therefore, the thermal head 1 shown in FIGS. 1 to 3 is obtained.

As described above, in the present embodiment, the dummy resistor patterns 41 are provided with the same pitches as that of the individual electrodes 7 (resistor patterns 40) in the dummy regions between the adjacent electrode groups A (more specifically, the actual regions having resistor patterns 40 formed beneath the individual electrodes 7 and the common electrodes 8 included in the electrode groups A). Consequently, when the resist patterns R are formed by exposure and development to form the resistor patterns 40, wettability difference of the developing solution does not occur in the vicinity of the boundaries between the actual regions and the dummy regions. Therefore, the resistor patterns 40 as well as the resist patterns R can be formed in specified shapes and sizes with high accuracy. As a result, since the heating value (heating resistance value) becomes uniform at each of the printing dots D, unevenness of the printing density is well controlled and thus excellent printing quality is obtained.

It is preferable that the dummy resistor patterns 41 be formed over all of the dummy regions with the same pitches as that of the resistor patterns 40 according to the present embodiment. However, the pitches are allowed to be about twice as large as the pitches of the resistor patterns 40. Specifically, for example, in the vicinity of the boundaries between the actual regions and the dummy regions, the dummy resistor patterns 41 are provided with the same pitches as that of the resistor patterns 40, and in the middle of the dummy regions, the pitches of the dummy resistor patterns 41 may be widened.

In the present embodiment, although the driving ICs 21 connected to the electrode pads 10 by a wire bonding method are provided on the driving unit 20 separate from the substrate 2, the electrode pads 10 and the driving ICs 21 may be provided on the same substrate.

As described above, the return-type thermal head 1 in which the individual electrodes 7 and the common electrodes 8 are connected to the printing dots D in the same direction to each other has been described. However, the invention can also be applied to the linear type thermal head in which the individual electrodes and the common electrodes are linearly disposed in the longitudinal direction of the heating resistors.

According to the invention, it is possible to obtain a thermal head capable of controlling the printing density by specifying shapes of the resistor patterns with high accuracy.

1. A thermal head comprising:
printing dots disposed with a predetermined pitch;
common electrode groups that apply a common electrical potential to all of the printing dots;
individual electrode groups individually connected to each of the printing dots, the common electrode groups and the individual electrode groups being arranged at predetermined intervals in each divided electrode group;
driving ICs that are provided in each divided electrode groups, and selectively supply currents to the printing dots through each of the individual electrodes to selectively supply a current to each of the individual electrodes included in each of the electrode groups; and
dummy resistor patterns formed at predetermined intervals in the regions between the adjacent electrode groups so as not to be connected to both the printing dots and the driving ICs.

2. The thermal head according to claim 1,
wherein the dummy resistor patterns are formed with the same pitches as minimum pitches of the common electrodes and the individual electrodes, which are included in the electrode groups.

3. The thermal head according to claim 1,
wherein the dummy resistor patterns are arranged parallel to the common electrodes and the individual electrodes which are included in the electrode groups.

4. The thermal head according to claim 1,
wherein the dummy resistor patterns are symmetric with respect to a middle position between the adjacent electrode groups.

5. The thermal head according to claim 1,
wherein the common electrodes and the individual electrodes are formed on resistor patterns, which constitute the printing dots and generate heat by supplying a current thereto, and the resistor patterns and the dummy resistor patterns are formed with a resistor film made of the same material.

6. The thermal head according to claim 1,
wherein each of the printing dots includes two heating resistors of which one pair of ends are connected to each other by a conductor, each of the individual electrodes is connected to another end of one heating resistor, and each of the common electrodes is connected to another end of the other heating resistor.

7. A method of manufacturing a thermal head, which includes:
providing printing dots with a predetermined pitch;
supplying common electrode groups that apply a common electrical potential to all of the printing dots;
connecting individual electrode groups individually to each of the printing dots, the common electrode groups and the individual electrode groups being arranged at predetermined intervals in each divided electrode group;
providing driving ICs in each divided electrode groups; and
forming dummy resistor patterns at predetermined intervals in regions between the adjacent electrode groups so as not to be connected to both the printing dots and the driving ICs,
wherein resistor patterns constituting the printing dots and the dummy resistor patterns are formed by a photo-lithography method at the same time.

8. The method of manufacturing a thermal head according to claim 7,
wherein the common electrode groups and the individual electrode groups are laminated on the resistor patterns.
